(19) United States
(12) Patent Application Publication
(10) Pub. No.: US 2012/0212102 A1
(43) Pub. Date: Aug. 23, 2012

(54) RESONANT TRANSDUCER AND ULTRASONIC TREATMENT DEVICE INCLUDING RESONANT TRANSDUCER

(76) Inventors: Yasutoshi HIRABAYASHI, Ashigarakami-gun (JP); Takamichi Fujii, Ashigarakami-gun (JP)

(21) Appl. No.: 13/348,196

(22) Filed: Jan. 11, 2012

(30) Foreign Application Priority Data
Feb. 23, 2011 (JP) 2011-037502

(51) Int. Cl. G10K 9/122

(52) U.S. Cl. 310/322

(57) ABSTRACT

A resonant transducer comprising:

a vibration plate; and

a piezoelectric element including a piezoelectric film and an upper electrode,

wherein a difference between a Young's modulus of the vibration plate and a Young's modulus of the piezoelectric film is not more than 20% with respect to the Young's modulus of the vibration plate.

### BACKGROUND OF THE INVENTION

1. Field of the Invention

The present invention relates to a resonant transducer and an ultrasonic treatment device including the resonant transducer and, more particularly, to a resonant transducer which can obtain a high vibration speed and an ultrasonic treatment device including the resonant transducer.

2. Description of the Related Art

Recently, in medical sites, in order to achieve early recovery after operation and reduce the load on a patient, it is required to minimize the size of an incised portion. As a method for this purpose, endoscopic surgery has been actively practiced. Various surgical tools have been developed for endoscopic surgery. This has expanded the application range of endoscopic surgery. Under the circumstances, an ultrasonic knife is expected as a tool for endoscopic surgery.

Patent literature 1 (Japanese Patent Laid-Open No. 2002-65689) described below discloses, as such an ultrasonic treatment device, an ultrasonic treatment device which excites ultrasonic vibration in a treatment portion via a piezoelectric element which generates ultrasonic vibration, a horn portion which increases the amplitude of the generated ultrasonic vibration, and a probe which transmits the vibration.

Non-patent literature 1 (Minoru Kurosawa and Takeshi Sasanuma, “Enhancement of Vibration Amplitude of Micro Ultrasonic Scalpel using PZT Film”, The Institute of Electronics, Technical Report of IEICE, US2009-109 (213) 31) proposes a micro ultrasonic scalpel using longitudinal vibration (vibration in a direction almost perpendicular to the living body surface to be excised), which is intended to be used for endoscopic surgery. This device excites longitudinal vibration in the d₃₁ mode of a piezoelectric film, and can incorporate a sensor device to detect a vibration speed.

### SUMMARY OF THE INVENTION

The ultrasonic treatment device disclosed in patent literature 1 uses a Langevin transducer which is bolted to a piezoelectric element so as to obtain a high vibration speed. The vibration speed of this ultrasonic treatment device is insufficient for incision, coagulation, and the like, and hence the device requires a horn portion which increases the vibration speed.

In order to increase the vibration speed by using the horn portion, however, the size of the vibration portion needs to be increased relative to the treatment portion. For this reason, when using the ultrasonic treatment device in an endoscope, since the size of the vibration portion is limited to a diameter of about 2 mm to 3 mm, the treatment portion is further reduced in size. This poses problems such as increased treatment time. The Non-patent literature 1 discloses a structure having a rectangular shape without any horn portion and a structure having a horn portion with a transformation ratio of 3.5. According to this literature, the vibration speed of the vibration portion with the rectangular shape is 2 m/s, and that of the vibration portion of the structure with the horn portion is 7 m/s. To perform incision and coagulation, the ultrasonic treatment device needs to have a vibration speed of 7 m/s, and hence the transformation ratio needs to be 3.5 or more. This will reduce the width of the treatment portion to less than 1 mm. In addition, the vibration torque is undesirably reduced in accordance with the transformation ratio.

The present invention has been made in consideration of the above situation, and has as its object to provide a resonant transducer which can obtain a high vibration speed and an ultrasonic treatment device including the resonant transducer.

In order to achieve the above object, according to the present invention, there is provided a resonant transducer comprising a vibration plate and a piezoelectric element including a piezoelectric film and an upper electrode, wherein a difference between a Young's modulus of the vibration plate and a Young's modulus of the piezoelectric film is not more than 20% with respect to the Young's modulus of the vibration plate.

In the present invention, the difference between the Young's modulus of the vibration plate and the Young's modulus of the piezoelectric film is preferably not more than 10% with respect to the Young's modulus of the vibration plate.

According to the present invention, since the difference between the Young's modulus of the vibration plate and the Young's modulus of the piezoelectric film is made to fall within 20%, preferably 10%, with respect to the Young's modulus of the vibration plate, the vibration speed can be increased by the resonant vibration of the vibration plate and piezoelectric film.

In the present invention, the vibration plate preferably performs stretching vibration in a direction horizontal to a surface on which the piezoelectric element is formed.

According to the present invention, since the vibration plate performs stretching vibration in the direction horizontal to the surface on which the piezoelectric element is formed, when the resonant transducer is used as an ultrasonic treatment device, it is possible to implement action of incision of the living body and hemostatic action by coagulation.

In the present invention, the vibration plate is preferably formed from one of titanium (Ti) and an alloy of titanium(Ti).

According to the present invention, since titanium or its alloy is used as a material for the vibration plate, it is possible to easily reduce the difference in Young's modulus between the vibration plate and the piezoelectric film formed thereon. In addition, when the resonant transducer is used as, for example, an ultrasonic treatment device, the device can be safely used in the body.

In the present invention, a thickness of the piezoelectric film is preferably not less than 1 μm and not more than 5 μm.

According to the present invention, setting the thickness of the piezoelectric film in the above range can reduce the size of the apparatus.

In the present invention, a mechanical quality factor Qm is preferably not less than 2000.

In the present invention, a mechanical quality factor Qm is preferably not less than 4000.

According to the present invention, setting the mechanical quality factor Qm in the above range can suppress heat generation in the resonant transducer, a high vibration speed can be obtained.

In order to achieve the above object, the present invention provides an ultrasonic treatment device including the resonant transducer described above.

Since the resonant transducer of the present invention can obtain a high vibration speed, a horn portion is not required or the transformation ratio can be reduced. This allows to increase the size of the treatment portion. Therefore, the resonant transducer can be suitably used as an ultrasonic treatment device.

According to the resonant transducer and the ultrasonic treatment device including the resonant transducer of the present invention, setting the Young's moduli of the vibration plate and piezoelectric film in desired ranges allows to obtain a high vibration speed.

### BRIEF DESCRIPTION OF THE DRAWINGS

FIG. 1 is a plan view showing the structure of a resonant transducer;

FIG. 2 is a sectional view showing the structure of the driving portion of the resonant transducer;

FIG. 3A is a schematic sectional view of an RF sputtering apparatus;

FIG. 3B is a view schematically showing a state during film formation;

FIG. 4 is a view showing the overall arrangement of an ultrasonic treatment device;

FIG. 5 is a graph showing the relationship between frequency and vibration speed in this embodiment; and

FIG. 6 is a graph showing the relationship between driving voltage and vibration speed in this embodiment.

### DETAILED DESCRIPTION OF THE PREFERRED EMBODIMENTS

A preferred embodiment of a resonant transducer and an ultrasonic treatment device including the resonant transducer according to the present invention will be described below with reference to the accompanying drawings.

### [Resonant Transducer]

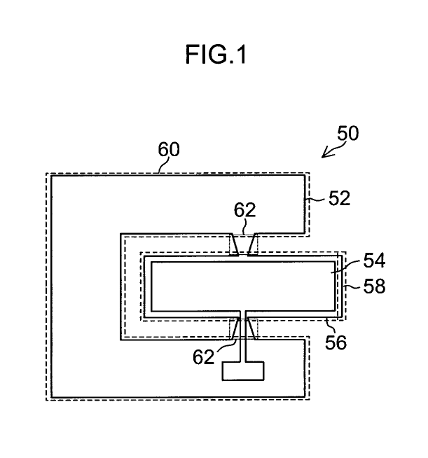

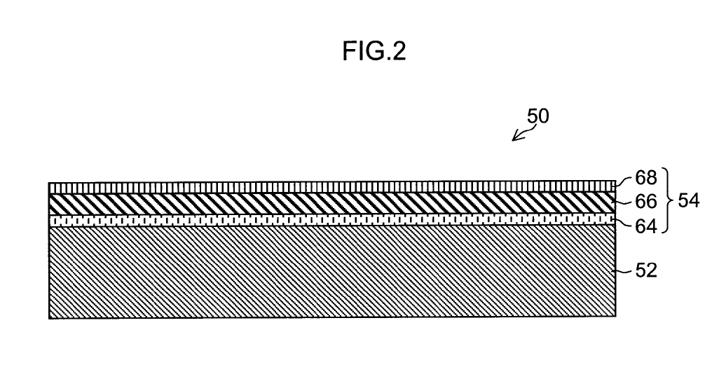

FIG. 1 is a plan view schematically showing an example of the structure of a resonant transducer 50 used in the present invention. FIG. 2 is a sectional view schematically showing the structures of a substrate (vibration plate) 52 and piezoelectric element 54 of a driving portion 56 of the resonant transducer 50 shown in FIG. 1.

As shown in FIG. 1, the resonant transducer 50 is constituted by the driving portion 56 which includes the piezoelectric element 54 and vibrates the substrate 52, a vibration portion 58 which is on the distal end of the substrate 52 and vibrates when the piezoelectric element 54 is driven, a support portion 60 which supports driving, and a fixing portion 62 which fixes the driving portion 56 to the support portion 60. Referring to FIG. 1, the piezoelectric element 54 is provided on part of the support portion 60 with the driving portion 56 and the fixing portion 62. The purpose of this structure is to connect an electrode to the piezoelectric element 54 on the support portion 60. The position where the piezoelectric element 54 is formed is not specifically limited as long as the piezoelectric element 54 is formed on the driving portion 56.

As shown in FIG. 2, the piezoelectric element 54 is formed by providing a lower electrode 64, a piezoelectric film 66, and an upper electrode 68 on the substrate 52.

### [Piezoelectric Element]

The piezoelectric element 54 used for the resonant transducer 50 of the present invention will be described next. As shown in FIG. 2, the piezoelectric element 54 is an element formed by sequentially stacking the lower electrode 64, the piezoelectric film 66, and the upper electrode 68 on the substrate 52, and is configured to apply an electric field to the piezoelectric film 66 in the thickness direction through the lower electode 64 and the upper electrode 68. When an electric field is applied to the piezoelectric film 66, the piezoelectric film 66 extends and contracts in a direction (d₃₁ direction) perpendicular to the electric field direction of the piezoelectric element 54, and hence stretching vibration occurs in the longitudinal direction of the substrate 52, i.e., the horizontal direction relative to the surface on the piezoelectric element 54 is formed.

As a material for the substrate 52, it is possible to use, for example, Ti, SUS, Al, or an alloy of Ti, SUS, Al. The difference between the Young's modulus of the substrate used as the substrate 52 and the Young's modulus of the piezoelectric film formed on the substrate is not more than 20% relative to the Young's modulus of the substrate. Of these materials, it is preferable to use Ti and alloy of Ti. Using Ti and alloy of Ti can easily make the Young's modulus difference from that of the piezoelectric film fall within a desired range. In addition, using such a substrate for an ultrasonic treatment device (to be described later) or the like allows its safe use. Letting a be the Young's modulus of the substrate and b be the Young's modulus of the piezoelectric film, the Young's modulus difference relative to the substrate can be obtained according to Young's modulus difference=(|−b|/a)×100(%).

The lower electode 64 can be provided as needed. If, for example, the substrate 52 is formed from a conductive material such as a metal, it is possible to directly form the piezoelectric film 66 on the substrate 52 without providing any lower electrode. The main component of the lower electode 64 is not specifically limited, and may be a metal or a metal oxide such as Au, Pt, Ir, IrO₂, RuO₂, LaNiO₃, or SrRuO₃, or a combination of Au, Pt, Ir, IrO₂, RuO₂, LaNiO₃, or SrRuO₃. The main component of the upper electode 68 is not specifically limited, and may be one of the materials exemplified for the lower electode 64 or an electrode material used for a general semiconductor process, such as Al, Ta, Cr, or Cu, or a combination of them.

As the piezoelectric film 66, it is possible to use one or more types of perovskite-type oxides represented by the following general formula (P):

general formula AₐB_{b}O₃ (P)

(wherein, A: A-site element including at least one kind of element including Pb; B: B-site element including at least one kind of element selected from the group consisting of Ti, Zr, V, Nb, Ta, Cr, Mo, W, Mn, Sc, Co, Cu, In, Sn, Ga, Zn, Cd, Fe, Ni, and a lanthanide element; and O: oxygen, although a=1.0 and b=1.0 are standard values, these values may deviate from 1.0 within a range in which perovskite structures can be formed)

Forming a piezoelectric film by using the vapor deposition method described below can form a piezoelectric film having a composition represented by 1.0≦a without losing Pb, thereby also forming a piezoelectric film having a Pb-rich composition represented by 1.0<a. The upper limit of a is not specifically limited, and it is possible to obtain a piezoelectric film having good piezoelectric performance as long as 1.0≦a≧1.3.

The thicknesses of the lower electode 64 and upper electode 68 are not specifically limited, and are, for example, about 200 nm. The thickness of the piezoelectric film 66 is not specifically limited, and is generally 1 μm or more, for example, 1 to 5 μm.

### [Method of Manufacturing Piezoelectric Film]

A method of manufacturing a piezoelectric film will be described next. It is possible to manufacture a piezoelectric film according to the present invention by forming a film by a vapor deposition method using a plasma. Film formation conditions can be determined based on the relationship between a film formation temperature Ts(° C.), Vs−Vf (V) which is the difference between a plasma potential Vs(V) in a plasma at the time of film formation and a floating potential Vf (V), and the characteristics of a film to be formed.

The vapor deposition methods that can be used include a sputtering method, ion beam sputtering method, ion plating method, and plasma CVD method. Film characteristics that can achieve the above relationship include the crystal structure of a film and/or a film composition. Adjusting the composition of a film can change the Young's modulus of a piezoelectric film.

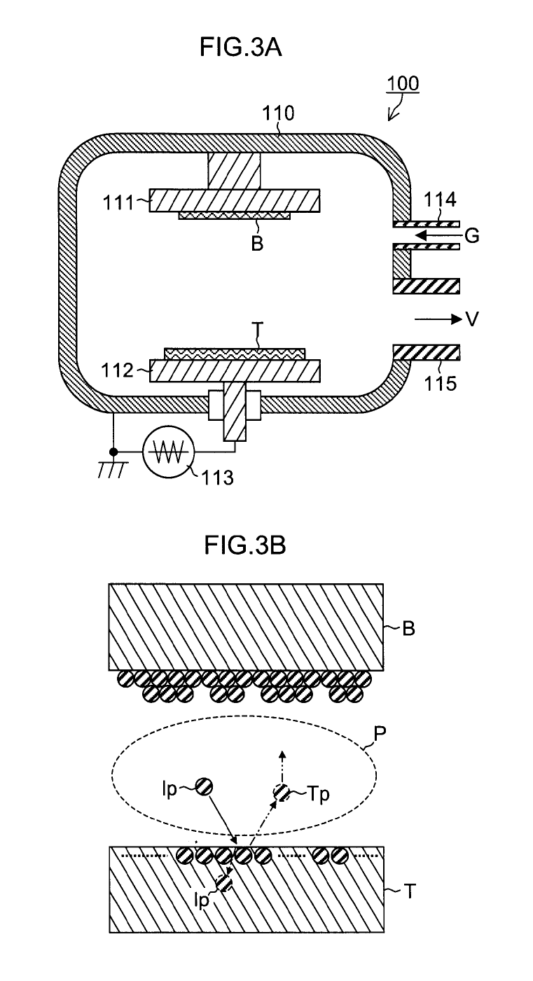

An example of the arrangement of a film formation apparatus using a plasma will be described by taking a sputtering apparatus as an example with reference to FIGS. 3A and 3B. FIG. 3A is a schematic sectional view of an RF sputtering apparatus. FIG. 3B is a view schematically showing a state during film formation.

An RF sputtering apparatus 100 is roughly formed from a vacuum chamber 110 internally including a heater 111 on which a substrate B is mounted and which can heat the substrate B to a predetermined temperature and a plasma electrode (cathode electrode) 112 which generates a plasma. The heater 111 and the plasma electrode 112 are spaced apart from each other so as to face each other, and a target T having a composition corresponding to the composition of a film to be formed is mounted on the plasma electrode 112. The plasma electrode 112 is connected to an RF power supply 113.

A gas introduction pipe 114 and a gas exhaust pipe 115 are attached to the vacuum chamber 110. The gas introduction pipe 114 serves to introduce a gas G necessary for the formation of a film into the vacuum chamber 110. The gas exhaust pipe 115 serves to perform exhaustion V of the gas in the vacuum chamber 110. As the gas G, for example, Ar or a mixed gas of Ar/O₂ is used. As schematically shown in FIG. 3B, the plasma electrode 112 discharges to plasmatize a gas G introduced into the vacuum chamber 110, thereby generating positive ions Ip such as Ar ions. The generated positive ions Ip sputter the target T. A constituent element Tp of the target T sputtered by positive ions Ip is discharged from the target and deposited on the substrate B in a neutralized or ionized state. Reference symbol P in FIG. 3B represents the plasma space.

The potential of the plasma space P corresponds to the plasma potential Vs (V). In general, the substrate B is an isolator and is electrically insulated from ground. The substrate B is therefore in a floating state. The potential of the substrate B corresponds to the floating potential Vf (V). It is thought that the constituent element Tp between the target T and the substrate B collides with the substrate B during film formation, with a kinetic energy corresponding to an acceleration voltage corresponding to the potential difference Vs−Vf between the potential of the plasma space P and the potential of the substrate B.

It is possible to measure the plasma potential Vs and the floating potential Vf by using a Langmuir probe. Increasing the voltage of the probe beyond the floating potential Vf will gradually decrease the ion current. As a result, only an electron current reaches the probe. This boundary voltage corresponds to the plasma potential Vs. The potential difference Vs−Vf can be changed by placing ground between the substrate and the target.

In the vapor deposition method using a plasma, factors that influence the characteristics of a film to be formed may include a film formation temperature, the type of substrate, the composition of an underlying film if it is formed beforehand on the substrate, the surface energy of the substrate, a film formation pressure, the amount of oxygen in an atmospheric gas, injection power, the distance between the substrate and the target, the electron temperature and an electron density in a plasma, the active species concentration and the life of active species in the plasma.

In the present invention, it is possible to form a film by using, in addition to the above vapor deposition method using a plasma, vapor phase methods such as a metal organic chemical vapor deposition (MOCVD) and a PLD (pulse laser deposition) method, liquid phase methods such as a sol-gel method and an organic metal decomposition method, and an aerosol deposition method. In addition, it is possible to form a film by directly bonding bulk ceramics to each other and thinning the resultant structure to a desired film thickness by polishing. The film forming method to be used to form a film is not specifically limited as long as the difference in Young's modulus between the substrate and the formed piezoelectric film can be made to fall within 20% relative to the Young's modulus of the substrate.

### [Performance of Piezoelectric Film]

It is possible to reduce the stress acting on the interface between the substrate and the piezoelectric film at the time of vibration of the piezoelectric film by changing the above film formation conditions so as to make the difference in Young's modulus between the substrate and the piezoelectric film fall within 20% relative to the Young's modulus of the substrate. This can improve a mechanical quality factor Qm. The mechanical quality factor Qm can be obtained from a frequency/vibration speed graph in the embodiment described later.

The mechanical quality factor Qm is a coefficient representing an elasticity loss due to vibration, and is represented by the reciprocal of a mechanical loss factor. When the piezoelectric element elastically vibrates, an internal loss occurs and is converted into heat. That is, if the mechanical quality factor Qm is low, since vibration is a factor for heat generation, a high vibration speed cannot be obtained.

In the present invention, the mechanical quality factor Qm increases when the difference in Young's modulus between the substrate and the piezoelectric film is made to fall within 20% relative to the Young's modulus of the substrate. This can suppress heat generation, and can obtain a high vibration speed. It is more preferable to make the difference in Young's modulus between the substrate and the piezoelectric film fall within 10%.

Making the difference in Young's modulus between the substrate and the piezoelectric film fall within 20% relative to the Young's modulus of the substrate can increase the mechanical quality factor Qm to 2000 or more. In addition, the mechanical quality factor Qm is preferably set to 4000 or more.

### [Ultrasonic Treatment Device]

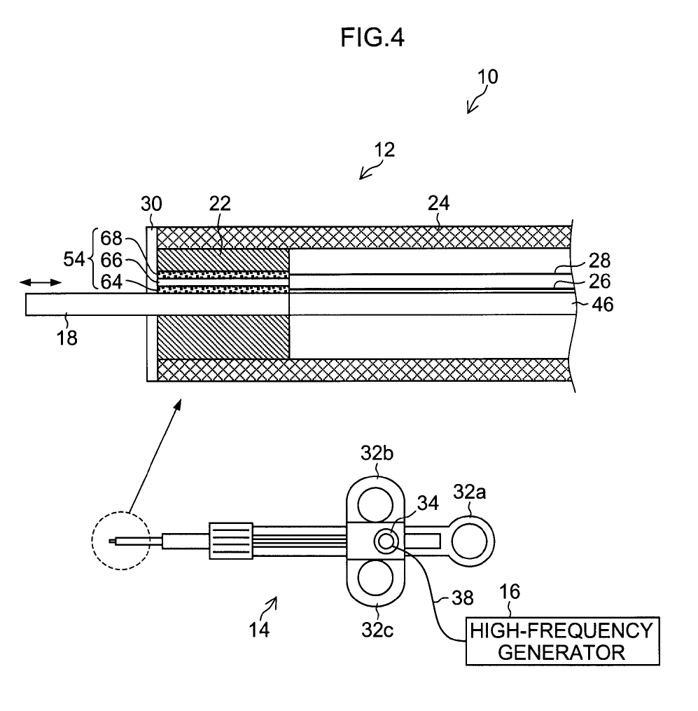

An example of the ultrasonic treatment device using the resonant transducer of the present invention will be described next. FIG. 4 is a view showing the overall arrangement of an ultrasonic treatment device including an ultrasonic knife as an example of the ultrasonic treatment device. An ultrasonic treatment device 10 includes a knife portion 12 functioning as an ultrasonic knife (scalpel) such as a needle-knife or a knife for peripheral incision and membrane separation (to be also referred to as a “dissection knife” hereinafter) in ESD treatment and an operation unit main body 14 which is operated by the operator to make the knife portion 12 function as an ultrasonic knife. The ultrasonic surgical apparatus 10 also includes a high-frequency generator 16 which applies a voltage to the knife portion 12. In the ultrasonic surgical apparatus 10, a blade portion 18 corresponds to the substrate 52 of the resonant transducer 50.

The knife portion 12 includes the blade portion (treatment portion) 18, a piezoelectric element 54, a blade fixing portion 22, a sheath (connecting portion) 24 having flexibility, a first electrode (ground potential) 26, a second electrode 28, a resin sealing member 30, and a flexible cord 46.

The operation unit main body 14 includes rings 32a, 32b, and 32c for the operation of the blade portion 18 and a connector 34 as a connecting terminal for the high-frequency generator 16.

Note that the connector 34 of the operation unit main body 14 is electrically connected to the high-frequency generator 16 through a high-frequency voltage cord 38.

The blade portion 18 of the knife portion 12 functions as a dissection knife used for peripheral incision, round incision (cut), and submucosal dissection in ESD treatment, and is configured to vibrate by the vibration of the piezoelectric element 54.

Increasing and decreasing the strength of an electric field applied to the piezoelectric element 54 will expand and contract the piezoelectric element 54, thereby making the blade portion 18 ultrasonically vibrate in the direction indicated by the arrow shown in FIG. 4. This makes it possible to perform incision.

The blade fixing portion 22 is fixed to the inside of the distal end of the sheath 24, and has a function of supporting the blade portion 18 so as to allow it to reciprocally move (move forward and retreat). That is, when the blade portion 18 protrudes and retreats from and into the distal end of the sheath 24, the blade fixing portion 22 supports the blade portion 18 so as to allow it to move forward and retreat with respect to the sheath 24.

The sheath 24 is made of an insulting material having flexibility and physically and electrically protects the blade portion 18, the piezoelectric element 54, the first electrode 26, and the second electrode 28.

The first electrode 26 and the second electrode 28 serve to apply a high-frequency voltage to the piezoelectric element 54. These electrodes are made of a conductive material and respectively coupled to the rings 32b and 32c.

The resin sealing member 30 is provided to seal the end of the sheath 24 which is located on the living body side. In the present invention, the piezoelectric element 54 can be provided in a portion which is inserted into the body, and hence is preferably covered with a resin to prevent electric shock. In addition, since the piezoelectric film 66 can be made of lead, the piezoelectric film 66 is preferably covered with a resin. Using a resin as a sealing material for the sheath 24 can reduce the influence of resonance frequencies at the time of driving of the blade portion 18.

The arrangement and operation of the operation unit main body 14 will be described next.

The operator inserts his/her thumb, index finger, and middle finger into the rings 32a of the operation unit main body 14, the rings 23b and 32c of the operation slider, respectively, and slides the operation slider along the operation unit main body 14. With this sliding operation, the blade portion 18 can move forward and retreat (reciprocally move) from and into the sheath 24 through the flexible cord 46 coupled to the operation slider.

The high-frequency voltage cord 38 from the high-frequency generator 16 is connected to the connector 34, and the first and second electrodes 26 and 28 are electrically connected to the connector 34. Therefore, this high-frequency voltage is applied to both the first and second electrodes 26 and 28 to vibrate the piezoelectric element 54. This makes the blade portion 18 ultrasonically vibrate and makes it function as a dissection knife.

The treatment device (endoscope) using the above ultrasonic knife has a forceps aperture of about 3 mm. The ultrasonic knife can increase the vibration speed of the vibration portion by being provided with a horn shape. However, increasing the enlargement ratio of the horn will limit the size of the aperture, resulting in a reduction in the size of the treatment portion (vibration portion). Reducing the treatment portion will increase the amount of operation required for treatment. This may prolong the surgical operation time. The ultrasonic knife in current use has a distal end diameter of about 1 mm, which corresponds to a transformation ratio of about 3. Assume that an exponential horn is to be used. In this case, since a transformation ratio can be obtained from the ratio between the diameter of the vibration portion and that of the treatment portion, the transformation ratio is preferably 2 or less. Since the vibration speed required for the ultrasonic scalpel is 7 m/s or more, the vibration speed with the rectangular shape having no transformation ratio is preferably 3.5 m/s or more.

Note that the resonant transducer of the present invention is not limited to the above ultrasonic knife, and can be used for various types of actuators, resonators, sensors, oscillators, and the like.

### EXAMPLE

A rectangular resonant transducer like that shown in FIG. 1 was manufactured by using a Ti-6AI-4V substrate made of a Ti alloy having a Young's modulus of 113 GPa. A vibration portion was fixed to a support portion through a fixing portion. The thickness of the substrate was 0.3 mm.

The 50-nm thick first layer made of TiW and the 150-nm thick second layer made of Ir were formed as a lower electrode on the substrate by the sputtering method. Lead zirconate titanate (PZT) films were formed on the lower electrode by the sputtering method with the power of the sputtering apparatus being set to 500 W (Example 1) and 700 W (Example 2). The thickness of the piezoelectric film was 4 μm. It is possible to change the content of lead in the piezoelectric film by changing the power and to change the Young's modulus in accordance with the content of lead.

The following were film formation conditions, and the film formation temperature was set to 550° C.:
film forming apparatus: Rf sputtering apparatus
target: Pb_{1.3}((Zr_{0.52}Ti_{0.48})_{0.88}N_{0.12})O₃ sintered body (Nb content in B site: 12 mol %)
substrate temperature: 450° C.
distance between substrate and target: 60 mm
film formation pressure: 0.29 Pa
film formation gas: Ar/O₂=97.5/2.5 (molar ratio)

The contents of lead in the formed piezoelectric films measured by x-ray fluorescence analysis were 1.05 (Example 1) and 1.10 (Example 2) in molar ratio. The Young's moduli measured by the nanoindenter method were 110 GPa (Example 1) and 101 GPa (Example 2).

A 50-nm thick first layer made of TiW and a 150-nm thick second layer made of Pt were formed as an upper electrode by using a metal mask so as to cover the entire range extending from an end portion of the vibration portion to a portion spaced apart from the end portion by 0.1 mm. In addition, an electrode pad was patterned on the support portion through the fixing portion.

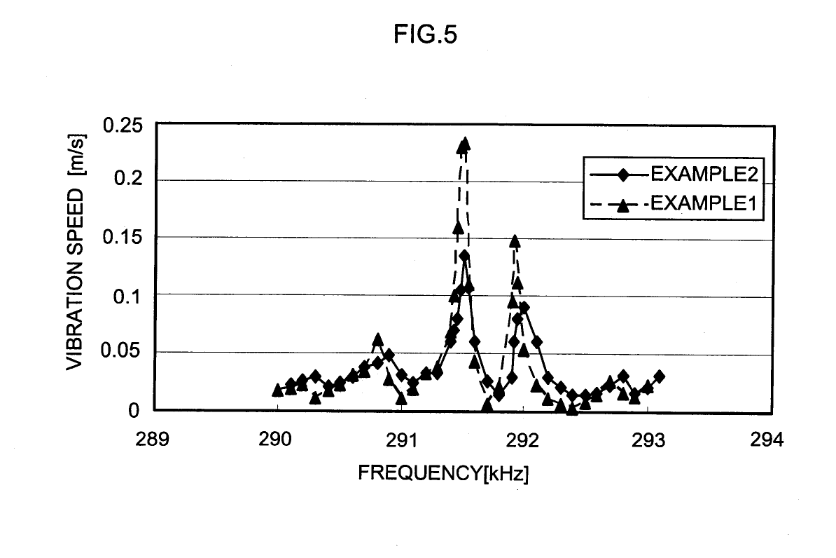

The vibration portion was driven by applying a voltage of 0.7 V to the Ti substrate electrically connected to the lower electrode and the electrode pad electrically connected to the upper electrode. The vibration speed of a side surface of the resonant transducer was measured by a laser Doppler vibration meter. FIG. 5 shows the results.

In both Examples 1 and 2, the maximum vibration speed was obtained at 291.50 Hz. When the mechanical quality factors obtained from the peak of this frequency, 291.50 Hz, Qm=4908 in Example 1, and Qm=2698 in Example 2.

Note that the mechanical quality factor Qm is used as an amount representing the sharpness of resonance, and is defined by an amplitude magnification at the time of resonance according to the following equation:

$$\frac{{x}_{max}}{{x}_{st}} = \frac{1}{2 ζ} = Qm \qquad [ Equation 1 ]$$

As a method of obtaining a Qm value, it is possible to obtain it as the ratio between a resonance frequency f₀ and frequency bandwidth Δf=f₂−f₁ at a point −3 dB away from the maximum amplitude of the resonant curve.

$$Qm = \frac{1}{2 ζ} = \frac{{f}_{0}}{{f}_{2} - {f}_{1}} \qquad [ Equation 2 ]$$

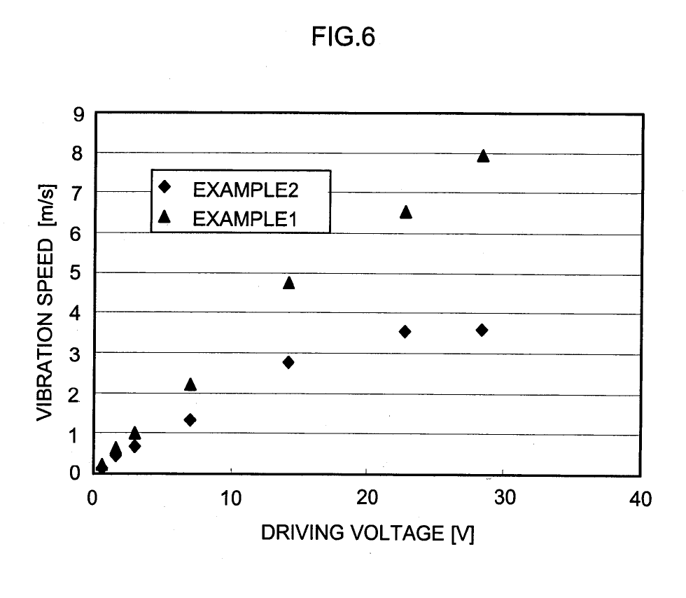

The voltage was then changed at 291.50 Hz, the resonance frequency, and the resultant vibration speeds were measured. FIG. 6 shows the results.

In Example 1, the vibration speed increased almost proportionally to the applied voltage, and a vibration speed of about 8 m/s could be obtained at 28 V. In Example 2, the vibration speed increased proportionally to the applied voltage up to 3 m/s. However, when the vibration speed reached about 3.5 m/s, the vibration speed did not increase even with an increase in voltage. This may be because, since the mechanical quality factor Qm is low, heat generation by mechanical vibration has an influence on the vibration speed.

According to non-patent literature 1 (Minoru Kurosawa and Takeshi Sasanuma, “Enhancement of Vibration Amplitude of Micro Ultrasonic Scalpel using PZT Film”, The Institute of Electronics, Technical Report of IEICE, US2009-109 (213) 31) presented as a conventional technique, FIG. 11 shows that a vibration speed of about 2 m/s is obtained at a driving voltage of 20 V when a piezoelectric element is formed on one surface of a substrate. The piezoelectric film described in non-patent literature 1 was formed by a hydrothermal method, and the Young's modulus of the film was about 50 GPa. Since the Young's modulus of the Ti substrate was about 100 GPa, the difference in Young's modulus between the substrate and the piezoelectric film was 50%.

In contrast to this, in Example 2, the Young's modulus difference was 12.9%, and the vibration speed at a driving voltage of 20 V was 3.5 m/s, which was about 1.8 times that in the conventional technique. It is therefore possible to obtain a vibration speed that allows to perform incision and coagulation with a lower transformation ratio.

In Example 1, the Young's modulus difference is 5.2%, and a vibration speed as high as 8 m/s can be obtained by increasing the driving voltage. This makes it possible to perform incision without having any horn. Since a vibration speed that allows to perform incision can be obtained without any horn, the size of the apparatus can be reduced. For example, this allows to provide a driving portion in a portion, of an endoscope, which is inserted into the body, thereby allowing to increase the design width of the treatment device.

What is claimed is:

1. A resonant transducer comprising:
a vibration plate; and
a piezoelectric element including a piezoelectric film and an upper electrode,
wherein a difference between a Young's modulus of the vibration plate and a Young's modulus of the piezoelectric film is not more than 20% with respect to the Young's modulus of the vibration plate.

2. The resonant transducer according to claim 1, wherein the vibration plate performs stretching vibration in a direction horizontal to a surface on which the piezoelectric element is formed.

3. The resonant transducer according to claim 2, wherein the difference between the Young's modulus of the vibration plate and the Young's modulus of the piezoelectric film is not more than 10% with respect to the Young's modulus of the vibration plate.

4. The resonant transducer according to claim 2, wherein the vibration plate is formed from one of titanium (Ti) and an alloy of titanium (Ti).

5. The resonant transducer according to claim 2, wherein a thickness of the piezoelectric film is not less than 1 μm and not more than 5 μm.

6. The resonant transducer according to claim 2, wherein a mechanical quality factor Qm is not less than 2000.

7. The resonant transducer according to claim 2, wherein the mechanical quality factor Qm is not less than 4000.

8. An ultrasonic treatment device comprising a resonant transducer defined in claim 2.
